(19) United States
(12) Patent Application Publication
(10) Pub. No.: US 2005/0108394 A1
(43) Pub. Date: May 19, 2005

(54) Grid-based computing to search a network

(75) Inventors: Richard A. Braun, Mechanicsville, VA (US); Matthew L. Overstreet, Richmond, VA (US); Steven D. Radabaugh, Richmond, VA (US)

Correspondence Address: BAKER BOTTS L.L.P., 2001 ROSS AVENUE, SUITE 600, DALLAS, TX, 75201-2980, US

(73) Assignee: Capital One Financial Corporation

(21) Appl. No.: 10/701,781

(22) Filed: Nov. 5, 2003

(51) Int. Cl. G06F 15/173

(52) U.S. Cl. 709/225

(57) ABSTRACT

A method and system for searching a network in which a server locates an idle client coupled to the network to perform a search, receives an acceptance notification from the client, stores the search status and stores the search result.

### TECHNICAL FIELD OF THE INVENTION

This invention relates generally to the field of grid-based computing and, more specifically, to a system and method for searching a network using grid-based computing.

### BACKGROUND OF THE INVENTION

Grid-based computing is a general term that refers to the use of resources in a network to perform computer functions. In the past, grid-based computing has been used in internal networks such as local area networks (LANs), wide area networks (WANs), the Internet, and other network computing systems in which a user may be logged on to the network or otherwise connected to the network, but not using the terminal. Generally, the user terminal has an application loaded thereon which sends a signal to a server also connected to the network informing the server that the terminal is available for grid-based computing. Typically, prior uses of grid-based computing have included using the resources of an idle terminal to analyze stored data accessible by the server.

Many companies, institutions, government agencies, and other entities install networks that allow members of the organization to communicate with each other in a dedicated network system. Often, these organizations use a common file system to store files within portions of the network. Many of these networks are geographically dispersed, with multiple servers located in multiple geographic locations. Typically, each location has a server or group of servers that stores files generated by systems or users located at that location.

### SUMMARY OF THE INVENTION

In accordance with the present invention, disadvantages and problems associated with previous techniques for searching for files within a network may be reduced or eliminated.

According to one embodiment of the invention, a method for searching a network is provided wherein a master server requests an idle client to perform a search. The method may include receiving an acceptance notification from the client, receiving the search results from the client, and storing the result. According to another embodiment, a method for searching a network is provided that includes a client notifying a master server of the client's availability. The client may also be operable to receive search criteria that defines the type of stored data in the network to be located by the client. Additionally, the method provides for recording a search status in a database and storing the search result in the database.

In another embodiment, a system for searching a network is provided that includes a master server operable to manage a search, a client operable to perform the search, and a database operable to store search data. An additional embodiment of the present invention includes a task management module operable to manage search criteria for a search within a network. Additionally, a client communication module is operable to locate an available client in the network and assign the search to the available client, and a data management module is operable to store search data in a database.

An advantage of an embodiment of the invention includes using multiple system resources to divide searches within a network to reduce network traffic. Another advantage is greater speed associated with searching for files within the network. Yet another advantage is increased efficiency for the use of network resources.

Certain embodiments of the invention may include none, some, or all of the above advantages. One or more other advantages may be readily apparent to one skilled in the art from the figures, descriptions, and claims included herein.

### BRIEF DESCRIPTION OF THE DRAWINGS

For a more complete understanding of the present invention and the advantages thereof, reference is now made to the following description taken in conjunction with the accompanying drawings:

FIG. 1 is a flow chart illustrating a method according to an embodiment of the present invention;

FIG. 2 is a flow chart illustrating a method according to an embodiment of the present invention;

FIG. 3 is a network architecture in accordance with an embodiment of the present invention; and

FIG. 4 is a system for searching a network in accordance with an embodiment of the present invention.

### DETAILED DESCRIPTION OF THE INVENTION

As the widespread use of the Internet has become more common, grid-based computing has emerged as a way for organizations, individuals, and companies to employ resources greater than those of an individual server or computer terminal to analyze large amounts of data. An application may be resident in the memory of both an administrator and a client computer. In a grid-based computing scenario, a client with grid-based computing software may become idle. Upon becoming idle, the client may notify the administrator that it is available to perform grid-based computing functions. The administrator then sends an amount of data to the client for analysis. Upon completing the analysis, the client returns the results of the analysis to the administrator.

Networks with associated servers coupled to the network can store large amounts of data for future use. The servers or computers coupled to the network may store the data in files or shared folders in memory units coupled to servers. For example, any personal computer owned by an individual coupled to the Internet is capable of transmitting files to other computers and/or users on the Internet, and receiving files from other users on the Internet. In a larger scheme, a server coupled to a network may have a large number of clients, nodes, or terminals coupled thereto along with multiple data storage devices, such as databases. The server may act as a conduit through which the clients may connect to the network. Such arrangements may allow for the clients to store data on the server or a database coupled to the server. Allowing the clients to store data on the server or an associated database provides centralized storage for the clients coupled to that particular server.

Organizations such as corporations, government agencies, non-profit organizations, and other public and private entities may use networks, such as a wide area network (WAN) or a local area network (LAN) to efficiently communicate between different locations and/or clients. Additionally, individuals use the Internet, or portions thereof, to communicate more effectively with other individuals or entities. In accordance with the present invention, the term “client” may be used to describe any server, personal computer, computer terminal, node, or any other device employing an input output interface, a network interface, and a data processing unit. The term “network” may include WAN, LAN, a metropolitan area network (MAN), portions of the Internet, or any other network, including an optical or wireless network, capable of transmitting data between clients.

These entities may employ a file storage structure involving servers located at different locations within the network, coupled to the network and able to communicate with each other via the network. Additionally, these system architectures may employ file storage systems that are geographically based according to the location of the servers. Accordingly, a user may be able to access the data storage system via a client coupled to a server in the system architecture. Using this access, the user may input data that is subsequently stored in the server to which the client is coupled. Large numbers of files may be stored in servers in the network that are searchable by clients coupled to servers in other geographic locations in the network using the system architecture. However, due to the large number of files stored in such a network, searching for specific files or file types is extremely difficult to perform by a single client. Moreover, searching for specific files or file types is extremely time consuming and consumes a vast amount of network resources. For example, any user desiring to find a specific file or file type may be required to search the entire network, routing through multiple servers and multiple geographic locations coupled to the network in order to search through what may be thousands or even millions of files to find the desired file or file type.

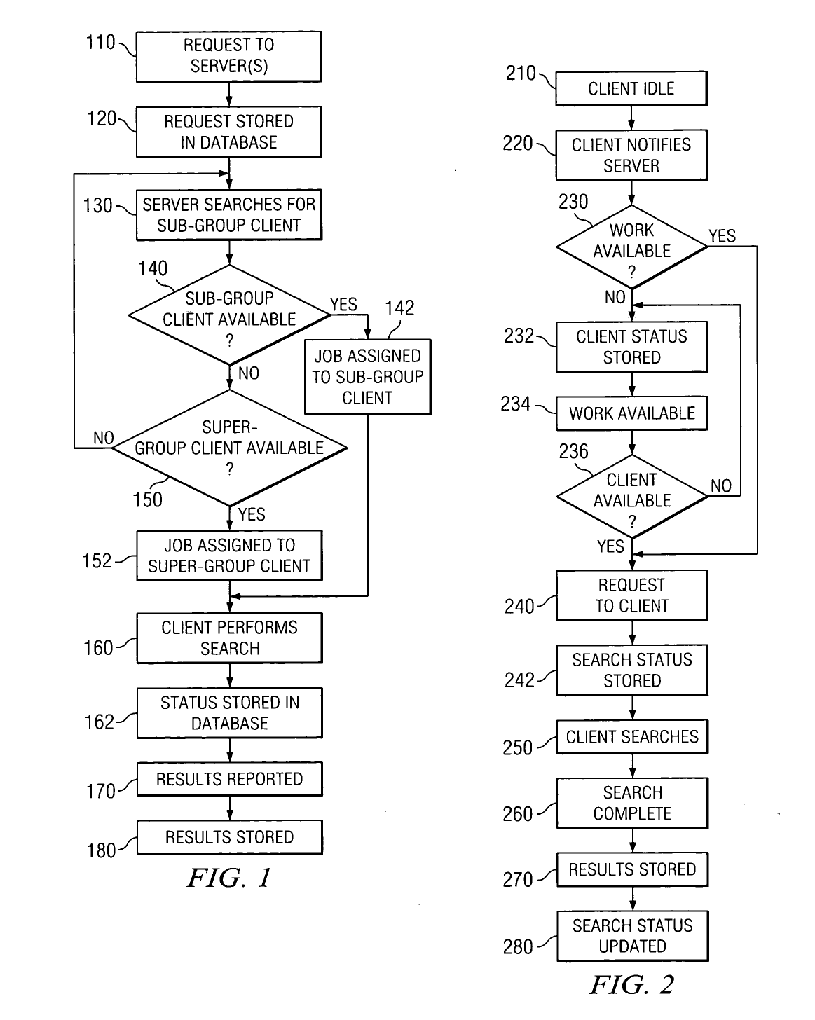

FIG. 1 illustrates a method for searching a network. At step 110, a request is sent to a server in the network. Preferably, the request includes a job identifier, a user ID, a password, a super-group, a sub-group, a server or folder or share, and a file or pattern indicating the type of data to search for. The job identifier is preferably unique for the particular search to be performed. The job identifier allows the server to direct the request to be stored in a database at step 120, so that the request may be recalled at a later date. A user identification, or “user ID”, may be included in the request. The user ID allows the client to access portions of the network to which the client may not normally have access. For example, a client may be a dedicated computer terminal for use by a user within the system architecture. A client may also be a computer terminal external to the system architecture, such as an individual computer coupled to the Internet. In a particular embodiment, a user may be a human who uses the client computer terminal to interface with other clients or with other locations coupled to the network. A user may have a dedicated user ID that notifies the server of the access that the user is allowed. Any particular search to be performed under the present embodiment may require the client to have greater access than is allowed according to the user ID of the client. In the case of a client external to the system, a user ID may be required for initial access into the network. Thus, the server may assign a separate user ID that allows the client to log into the network at a higher access level. Accordingly, a password corresponding to the search user ID may be provided that allows the network to authenticate the user ID provided for the job identifier.

Additionally, the “super-group” and “sub-group” preferably identify a server group and server sub-group within the system architecture. For example, a super-group may be defined as all of the servers located at a campus in a particular network, whereas a sub-group may be a group of servers or single server located in a building of the campus, wherein the campus may be coupled to the network through the super-group. Thus, a client may be coupled to a sub-group within a super-group coupled to the network.

The server or folder or share included in the request may identify a specific folder that the search is directed to find. Additionally, a particular type of file or data may be requested. Typically, a file will have an associated suffix. By way of example only, and not by way of limitation, this suffix allows certain applications, such as Microsoft® Excel® or other proprietary programs that have a suffix (such as “*.xls” for Excel) to readily retrieve files associated with the application. Accordingly, the file pattern of “*.xls” will direct the client to search for all Microsoft Excel spreadsheet files within the super-group and/or sub-group, if provided. If no sub-group or super-group is provided for the search, the search may be directed to the entire network based on the file pattern, and/or server, folder, or share provided in the search request.

At step 130 the server preferably searches for a sub-group client or clients coupled to the sub-group within which the data resides. Step 130 may also include searching for multiple clients to perform a search simultaneously. If no sub-group clients are available, at step 140 the sub-group server queried may attempt to discern if one or more super-group clients are available to perform the search at step 150. If no super-group clients are available at step 150, the server preferably continues to search for a sub-group client that becomes available or a super-group client that comes available by returning to steps 130, 140 and 150, respectively. In a particular embodiment, the server may search for an available client anywhere in the network or for an external client. If no client is available for the search, in the present embodiment the system may remain idle with the search waiting to be assigned until a client becomes available within the system. In another embodiment, the server may return the request to the master server informing it that no search can be performed (not explicitly shown).

If, at step 140 a sub-group client is available, at step 142 the search is preferably assigned to the sub-group client. The search may also be referred to as a query and may include some or all of the following information: a job identifier, a user identification to grant the required level of access to the client or clients performing the search, a password to authenticate the user ID, a general location identifier that preferably limits the portion or portions of the network to be searched, a specific location identifier, if known, to further limit the portions of the network to be searched, a type of data to be searched for, such as a file pattern, data content, file suffix, file size, or other data type. At step 160, the client may perform the search within the sub-group and at step 162 the job status is stored in the database. The job status may be stored in the database by the server originally receiving the request returning to the master server the IP (Internet protocol) address of the specific client performing the search, along with the job identifier corresponding to the search. If, at step 140, no sub-group client is available, but at step 150 a super-group client is available, the job is preferably assigned to the super-group client at step 152, and the client performs the search at step 160. Again, at step 162 the job status is preferably stored in the database by the server receiving the initial query returning to the master server the client IP address that has been assigned the search corresponding to the job identifier for storage in the database.

Once the search has been completed, at step 170 the client may report the search results, and at step 180 the results may be stored in the database. Preferably, the database has at least two sections that allow for search status to be recorded in one section and search results to be stored in another section. Additionally, access to the storage database may be gained through the master server, or in other embodiments, individual clients, sub-group servers, or super-group servers may be granted access to the storage database directly. In a particular embodiment, several responses for a search may be entered into the database as search results. For example, a search result may contain any or all of the following: file name, job identifier, super-group in which the file was located, sub-group in which the file was located, folder, file share, or sub-folder in which the file was located, time and date of the file's creation, storage, or modification, and the size of the file. Other appropriate parameters or characteristics may also be recorded.

It should be understood that if a client becomes actively engaged by a user, and thus unable to use client resources for the search, the client may notify the master server of its unavailability. Upon notification from the client that the client is no longer actively performing the search, the master server preferably updates the job status to reflect the suspension of the search in the database. Additionally or alternatively, the server may search for a different client to perform the suspended search.

FIG. 2 illustrates an alternative embodiment of the present invention in which a method for identifying an idle client is provided. At step 210, a client becomes idle. “Idle” may be defined as a client that has not been accessed for a user's purposes within the network for a specified period of time. For example, after a screen saver is activated on the client after a period of user inactivity, such as in the case of a user terminal, the client may automatically notify the master server that the client is available by providing the client's IP address. This notification may constitute the request by the client for work from the master server at step 220. Additionally, “idle” may refer to a client engaged by a user, but with a minimum level of system resources available for search applications, such as processing capacity, RAM, or any other system resource that may be used for searching a network. The server may actively or passively search for available clients. This may be accomplished by super-group or sub-group servers monitoring the processing status of the clients coupled thereto. At step 230, the master server determines whether any work is available for the client. The determination of whether work is available at step 230 may depend on the client's location within the network, i.e., whether any files need to be searched within the sub-group or super-group to which the client is coupled. In an alternative embodiment, the availability of a search for the client may be determined by the type of file to be searched for, the type of folder to be searched, or the relative proximity of the client to any other servers or system resources with files available for search.

In the case of a server as a client, upon an extended period of inactivity, and/or when a minimum number of users have active connections to the server or some other suitable criterion, the server may notify the master server with the server's IP address that the server is available to commit server resources to performing a search.

At step 240, the master server directs a search request to the client. The search request may include any or all of the information listed as the search request criteria provided in accordance with FIG. 1 at step 110. At step 242, the master server preferably stores the search status in the database. At step 250, the client performs the search. At step 260, the client completes the search and the results may be stored at step 270.

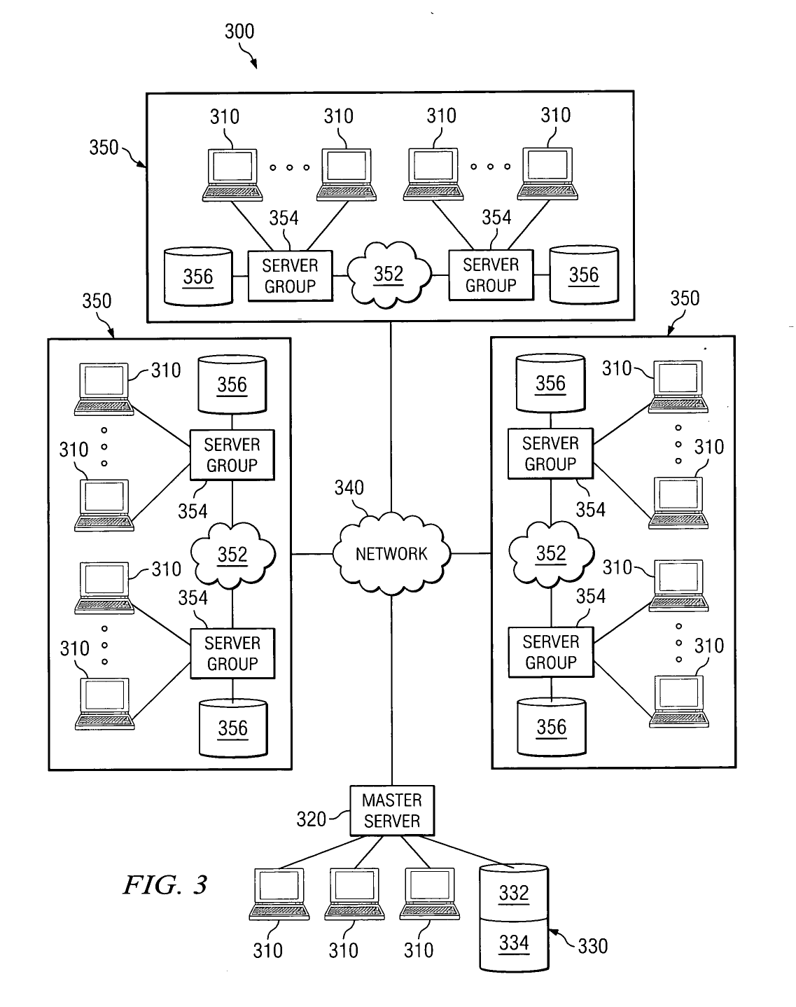

FIG. 3 illustrates a system 300, in which embodiments of the present invention may be performed. The architecture of system 300 is provided by way of example only. Thus, it should be understood that different embodiments of the present invention may be performed in different architectures based on the subject matter of the invention as defined by the claims. A system 300 includes multiple clients 310 coupled to server groups 354. Additionally, clients 310 may be coupled to master server 320. Clients 310 may be user terminals, individual servers, or any other device capable of processing information, or performing a search for files or folders in a network. Master server 320 is preferably operable to administer a search for files, folders, or any combination thereof over network 340.

Super-groups 350 may include clients 310, server groups 354 coupled to each other by a sub network 352, and data storage units 356 coupled to server groups 354. Individual clients 310 are coupled to server groups 354 within a geographical region that is closer in proximity to another server group 354 within super-group 350 than to server groups in other super-groups 350. For example, a campus of a typical corporation may have several server groups, or sub-groups, located on the campus. The campus may be geographically separate from other campuses within the network architecture of the organization. Thus, in a particular embodiment, a super-group 350 may contain two buildings of a campus, each building housing a server sub-group 354 connected through a sub-network 352 to another building housing a server group 354 with clients 310 coupled thereto. Each super-group 350 is preferably coupled via network 340 to master server 320. Additionally, a data storage device 330 is preferably coupled to master server 320. Data storage device 330 may have at least two storage areas 332 and 334. In a particular embodiment, storage area 332 may be operable to store search status, whereas data storage area 334 may operable to store search results, or vice versa.

According to an embodiment of the invention, and in accordance with FIG. 3, the master server 320 is preferably operable to administer or manage the search. This management may include generating search parameters for specific search requests, assigning searches to individual clients, and directing the database to store search information or search data. Once a search request has been generated by the master server 320, possibly by input from a client 310 or an end user accessing a client 310, master server 320 preferably directs the search request to servers located in super-groups 350, servers located in server groups 354, or to individual servers within the network. In a particular embodiment, any client 310 is preferably operable to perform the search request. However, it may be desirable to direct the search request to a specific server super-group, or server sub-group, in order to reduce traffic over network 340, so that a client 310 located in a specific server super-group or sub-group will search only within that super-group or sub-group, respectively. Upon notification of a server group, client, or super-group, the master server preferably receives a notification from a client within the group requested that the client is available to perform the search. Sending the search request to the server or server group may include all necessary search parameters for the client to perform the search. In such an embodiment, the response by the client that it is available to perform the search is all that is necessary to allow master server 320 to direct data storage unit 330 to store the search status in search status section 332 of database 330. In an alternative embodiment, the master server 320 may not transmit the search criteria to the specific client until a client has notified master server 320 that it is available to perform the search. This arrangement may be preferable in order to further reduce network traffic so that less information is sent to individual clients by the master server. Additionally, master server 320 may direct database 330 to store all search parameters generated for a particular search in the search status section 332 of database 330. Thus, when master server 320 receives notification from a client 310, the master server is preferably able to update the search status by directing database 330 to store the client responsible for the search with the originally stored job identification in search status 332. Upon receiving notification from client 310 that a search has been completed, the client may respond with the results of the search to master server 320 via network 340. Upon receiving the results of the search, master server 320 preferably directs database 330 to store the search results in search results portion 334 of database 330.

In the search request, master server 320 may provide for a client 310 to have greater access to network resources than a normal user of a client 310 is authorized. In such a case, the search request may include an alternative user directory identification or user ID, with an associated password, that is preferably operable to authenticate the user identification for the user directory access. Additionally, the search request may direct the client 310 to search in a specific super-group, sub-group, or other portion of the network for a specific type of file as defined by a file pattern, or group of file patterns. Additionally, the search results preferably include the job identifier, the location of the file, including the server on which the file was located, the associated storage of a separate client 310 on which the file was located, the file folder, file share, or file directory in which the file was located, the name of the file, as well as the date and time and/or size of the file that was located.

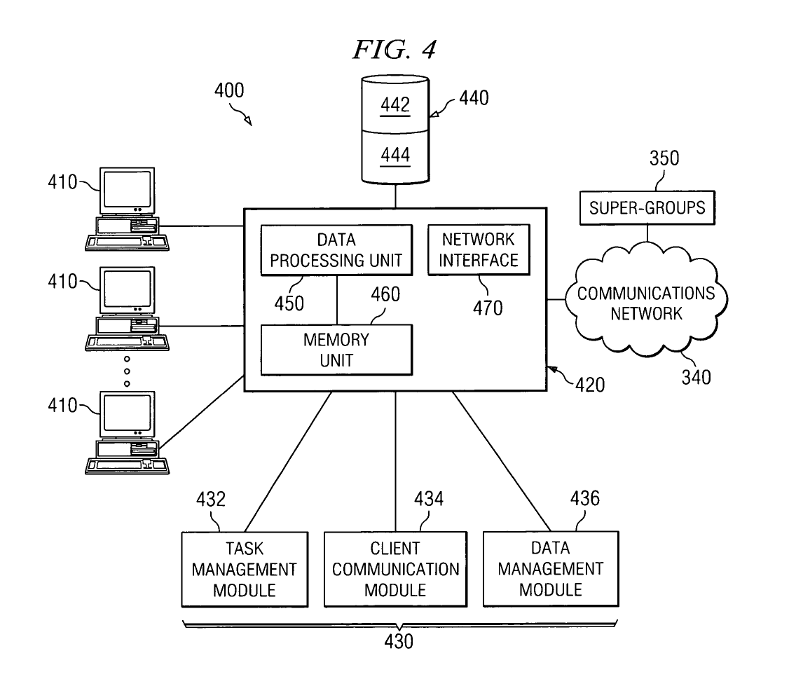

FIG. 4 illustrates a system 400 for searching a network according to another embodiment of the present invention. Clients 410 may be coupled to a master server 420. System 400 may include components of an organization having one or more operator terminals or clients 410, a master server 420, one or more function modules 430, a database 440, and super-groups 350. An organization's network structure may have components not explicitly illustrated in FIG. 4. The various components may be located at a single site or, alternatively, at a number of different sites. The components of system 400 may be coupled to each other using one or more links, each of which may include one or more computer buses, local area networks (LANs), metropolitan area networks (MANs), wide area networks (WANs), portions of the Internet or any other appropriate wireline, optical, wireless, or other links allowing users, terminals, or clients, to communicate over a network 340. A client 410 may provide an operator access to master server 420 to configure, manage, or otherwise interact with master server 420. An operator terminal 410 may include a computer system (which may include one or more suitable input devices, output devices, processors and associated memory, mass storage media, communication interfaces, and other suitable components) or other suitable device.

Master server 420 may manage data associated with the organization's business or other activities, which may in particular embodiments include creating, modifying, and deleting data files associated with the organization's operations or in response to data received from one or more clients 410, function modules 430, or super-groups 350. Additionally, master server 420 may call one or more function modules 430 to provide particular functionality according to particular needs, as described more fully below. Master server 420 may include a data processing unit 450, a memory unit 460, a network interface 470, and any other suitable components for managing data associated with organizational needs. The components of master server 420 may be supported by one or more computer systems at one or more sites. One or more components of master server 420 may be separate from other components of master server 420, and one or more suitable components of master server 420 may, where appropriate, be incorporated into one or more other suitable components of master server 420. Data processing unit 450 may process data associated with organizational business, which may include executing coded instructions (which may in particular embodiments be associated with one or more function modules 430). Memory unit 460 may be coupled to data processing unit 450 and may include one more suitable memory devices, such as one or more random access memories (RAMs), read-only memories (ROMs), dynamic random access memories (DRAMs), fast cycle RAMs (FCRAMs), static RAMs (SRAMs), field-programmable gate arrays (FPGAs), erasable programmable read-only memories (EPROMs), electronically erasable programmable read-only memories (EEPROMs), microcontrollers, or microprocessors. Network interface 470 may provide an interface between master server 420 and communications network 340 such that master server 420 may communicate with super-groups 350, their associated server groups and clients 310, as well as any other system coupled to network 340.

A function module 430 may provide particular functionality associated with handling organizational data or handling data transactions according to system 400. As an example only, and not by way of limitation, a function module 430 may provide functionality associated with search or task management, client communication, data management, billing, account management, or billing management. A function module 430 may be called by master server 420 (possibly as a result of data received from a client 410, or a client 310 within a super-group 350 as disclosed by FIG. 3, or any other component coupled to communications network 340) and, in response, provide the particular functionality associated with function module 430. A function module 430 may then communicate one or more results to data processing unit 450 or one or more other suitable components of master server 420, which may use the communicated results to create, modify, or delete one or more data files associated with one or more processors, provide data to an operator at operator terminal 410 or super-groups 350, or perform any other suitable task. Function modules 430 may be physically distributed such that each function module 430, or multiple instances of each function module 430, may be located in a different physical location geographically remote from each other and/or from master server 420.

In the embodiment shown in FIG. 4, function modules 430 include a task management module 432, a client communication module 434, and a data management module 436. According to one embodiment of system 400, task management module 432 is preferably operable to generate search criteria for a search to be performed within a network architecture such as that illustrated by FIG. 3. Search criteria generated by task management module 432 may be entered by a user at a client 410, selected from criteria previously stored in database 440, or any other suitable source for generating search criteria. Search criteria may include any number of individual criteria and/or criteria designed to allow a client coupled to master server 420 via network 340 to search the system architecture illustrated by FIG. 3 to locate a file, type of file, group of files, or any other data resident in the system. For example, the search criteria generated by task management module 432 may provide a location to be searched, a type of file to be searched, a type of folder to be searched, a type of file group to be searched, a specific group of files relating to a specific application, a specific group of files associated with a particular topic, or any other identifier enabling a client 310 or 410 to locate desired data stored within systems coupled to network 340.

After task management module 432 generates search criteria, client communication module 434 preferably locates an available client in the network to assign the search to the client. The client to perform the search may be a client 410 or a client 310 located within super-group 350 as described by FIG. 3. Various suitable methods exist for locating a client 310 or a client 410 for performing a search within the system. In one embodiment, the client may be located by the client being idle for a predetermined period of time. The predetermined period of time may be defined by the length of time the client is idle and may notify master server 420 by sending its Internet protocol (IP) address when the client 310 automatically goes into a screensaver mode. In an alternative embodiment, when a client 310 or a client 410 has been idle for a specific period of time a server within super-group 350 may identify the idle client within the super-group 350 as being a client operable to perform a search based on the search criteria generated by task management module 432 and transmitted to super-group 350 as instructed by client communication module 434. Client communication module 434 may also be operable to receive communications from a client via network 340 to update a job status.

The task status preferably is managed by data management module 436 and stored in database 440. Database 440 preferably has at least two sections. In one embodiment, database 440 has a search status section 442 and a search result section 444. After task management module 432 has generated search criteria for transmission to a client, data management module 436 may operate to direct master server 420 to store the search criteria in the search status section 442 of database 440. Additionally, search status section 442 of database 440 may be operable to store the status of any individual search by a unique job identifier attached to the search criteria generated by task management module 432. Data management module 436 is preferably operable to store search status in database 440 by directing search status section 442 to store searches that have not been completed and labeling them as awaiting search, in progress, suspended, or any other search status that allows the status of a search to be readily ascertained.

For example, once a search has been generated by task management module 432, data management 436 may direct master server 420 to store a search criteria as a job that is “awaiting search”. Once client communication module 434 has established communication with an individual client and assigned the individual search, data management module 436 preferably directs master server 420 to update the status of the search in database 440 as “in progress”. If for some reason, the client performing the search becomes engaged by a user, the search may be suspended. In such a case, data management module 436 preferably directs master server 420 to direct database 440 to update the status of the search to “suspended.”

Upon completion of a search, a client 410 or a client 310 preferably transmits the results of the search via communications network 340 to master server 420. Additionally, a client may transmit to data management 420 a client status informing master server 420, and specifically client communication module 434, whether or not the client is available for additional searches, or whether the client is unavailable. Upon receiving the search results, data management module 436 preferably directs database 440 to update the search status in search status section 442 that the search is complete. Additionally, data management module 436 preferably directs database 440 to store the search result section 444 of database 440. Preferably, the search results are stored according to the unique job identifier listed in the search status section 442 of database 440 so that the search criteria are easily recalled as needed.

Although the present invention has been described in detail, it should be understood that various changes, substitutions, and alterations may be made, without departing from the spirit and scope of the present invention as defined by the claims.

1. A method for searching a network, comprising:
receiving a request to perform a search, the search comprising determining the location of stored data within the network, the network comprising a plurality of clients;
receiving notification from at least one of the plurality of clients, each notification indicating the availability of resources associated with the respective client;
determining one or more clients having available resources for the search based at least on the notification received from the at least one of the plurality of clients;
distributing a search request to the one or more clients having available resources;
performing the search by using at least a portion of the available resources of the one or more clients; and
receiving search results from the one or more clients.

2. The method of claim 1, wherein the one or more clients comprises one or more servers within the network, the server operable to search the network to determine the location of the stored material.

3. The method of claim 1, wherein the one or more clients comprises one or more user terminals, the one or more user terminals operable to input data to and receive data from a server coupled to the network.

4. The method of claim 1, wherein the search request further comprises querying at least one server within the network, the query operable to determine the location of any clients in the network.

5. The method of claim 1, wherein the search request further comprises a job identifier.

6. The method of claim 4, further comprising a master server operable to receive the notification from the one or more clients, the master server further operable to store the notification in a database.

7. The method of claim 6, wherein the database is operable to store multiple notifications in the database.

8. The method of claim 6, wherein the master server is further operable to receive the search results and store the search results in a database.

9. The method of claim 8, wherein the master server is further operable to store search results from multiple clients and multiple searches in the database.

10. The method of claim 1, wherein the notification comprises an IP address.

11. The method of claim 1, wherein the stored data is a file.

12. The method of claim 1, wherein the stored data is a folder.

13. The method of claim 1, wherein the stored data is a file group, the file group comprising files associated with a specific application.

14. The method of claim 1, wherein the search results comprise a file name.

15. The method of claim 5, wherein the search results comprise the job identifier.

16. The method of claim 1, wherein the search results comprise a general location identifier, the general location identifier corresponding to a first range of IP addresses operable to define a server group to which the node is coupled.

17. The method of claim 16, wherein the search results further comprise a specific location identifier, the specific location identifier corresponding to a second range of IP addresses operable to define a server sub-group coupled to the server group, the node coupled to the sub-group.

18. The method of claim 13, wherein the search results comprise a folder, the file located in the folder.

19. The method of claim 17, wherein the search results further comprise the job identifier.

20. The method of claim 18, wherein the search results further comprise a general location identifier, the general location identifier corresponding to a first range of IP addresses operable to define a server group to which the node is coupled.

21. The method of claim 19, wherein the search results further comprise a specific location identifier, the specific location identifier corresponding to a second range of IP addresses operable to define a server sub-group coupled to the server group, the node coupled to the sub-group.

22. The method of claim 20, wherein the search results further comprise a time, the time defining when the file was created on the network.

23. The method of claim 21, wherein the search results further comprise a size of the file, the size corresponding to the number of bytes of data contained in the file.

24. The method of claim 5, wherein the search request further comprises a user identification, the user identification operable to assign an access level to the one or more clients, wherein the access level allows the one or more clients to search any server corresponding to the access level.

25. The method of claim 24, wherein the search request further comprises a password, the password corresponding to the user identification, the password operable to authenticate the access level, wherein the authentication is necessary to allow the one or more clients to search the network at the access level.

26. The method of claim 24, wherein the search request further comprises a general location identifier, the general location identifier corresponding to a first range of IP addresses operable to define a server group to which the one or more clients is coupled, wherein the server group defines a parameter of the search.

27. The method of claim 26, wherein the search request further comprises a specific location identifier, the specific location identifier corresponding to a second range of IP addresses operable to define a server sub-group to which the one or more clients is coupled, wherein the server sub-group further defines the parameter of the search.

28. The method of claim 27, wherein the search request further comprises a folder, the folder further defining the parameter of the search.

29. The method of claim 28, wherein the search request further comprises a file pattern, the file pattern operable to define the type of data in the search.

30. The method of claim 29, wherein the file pattern comprises a file suffix.

31. The method of claim 29, wherein the file pattern comprises a file size.

32. The method of claim 29, wherein the file pattern is a text search.

33. A method for searching a network, the network having one or more servers and one or more clients, comprising:
notifying a first server of the availability of at least one client;
receiving search criteria from the first server, the search criteria at least defining a type of stored data in the network to be located by the at least one client;
initiating a search;
recording a search status in a database; and
storing a search result in the database.

34. The method of claim 33, wherein the notification comprises at least one IP address, the at least one IP address corresponding to the at least one client.

35. The method of claim 33, wherein the notification is sent by the at least one client.

36. The method of claim 33, wherein the notification is sent by a second server, the second server coupled to the network and operable to monitor system resource availability of the at least one client.

37. The method of claim 33, wherein the search criteria further comprises a job identifier unique to the search.

38. The method of claim 37, wherein the search criteria further comprises a user identification, the user identification operable to assign an access level to the node, wherein the access level allows the node to search any server corresponding to the access level.

39. The method of claim 38, wherein the search criteria further comprises a password, the password corresponding to the user identification, the password operable to authenticate the access level, wherein the authentication is necessary to allow the node to search the network at the access level.

40. The method of claim 39, wherein the search criteria further comprises a general location identifier, the general location identifier corresponding to a first range of IP addresses operable to define a search location.

41. The method of claim 40, wherein the search criteria further comprises a specific location identifier, the specific location identifier corresponding to a second range of IP addresses operable to further define the search location, the second range of IP addresses further operable to define a server sub-group within the server group.

42. The method of claim 40, wherein the at least one client is coupled to the server group.

43. The method of claim 41, wherein the at least one client is coupled to the server sub-group.

44. The method of claim 41, wherein the search criteria further comprises a folder, the folder further defining the search location.

45. The method of claim 44, wherein the search criteria further comprises a file pattern, the file pattern operable to define the type of stored data subject to the search, the file pattern comprising an application suffix.

46. A system for searching a network, comprising:
a server operable to manage a search, the management comprising generating search parameters and assigning the search, the search comprising locating stored data in the network;
at least one client operable to perform the search, the client having access to the network and operable to receive the assignment; and
a database operable to store search data, wherein the search data comprises a search status and a search result.

47. The system of claim 46, wherein the server is further operable to receive a notification of client availability, the notification operable to inform the server that the at least one client has been assigned the search.

48. The system of claim 47, wherein the database is further operable to store the notification as a portion of the search status.

49. The system of claim 46, wherein assigning the search to the client comprises sending at least one search parameter to the client, the at least one search parameter comprising a file pattern operable to define the stored data subject to the search.

50. The system of claim 49, wherein the server directs the database to store the at least one search parameter as the search status.

51. The system of claim 50, wherein the at least one search parameter further comprises:
a search identifier unique to the search;
a user identification operable to assign an access level to the client; and
a password operable to authenticate the access level, the password corresponding to the user identification.

52. The system of claim 50, wherein the at least one search parameter further comprises a general location identifier corresponding to a first range of IP addresses, the first range of IP addresses corresponding to the location of the search.

53. The system of claim 52, wherein the at least one search parameter further comprises a specific location identifier corresponding to a second range of IP addresses, the second range of IP addresses located within the first range of IP addresses and corresponding to the location of the search.

54. The system of claim 52, wherein the at least one search parameter further comprises a folder, the folder corresponding to the location of the search.

55. The system of claim 46, wherein the search result comprises:
a search identifier unique to the search;
a file name; and
a file location operable to identify the portion of the network in which the file is stored.

56. A system for searching a network, comprising:
a task management module operable to manage search criteria for a search within the network, the search comprising locating stored data within the network;
a client communication module operable to locate at least one available client in the network and assign the search to the at least one available client; and
a data management module operable to store search data in a database.

57. The system of claim 56, wherein the task management module is further operable to receive the search criteria as input from a user.

58. The system of claim 56, wherein the search criteria comprises:
a file type; and
a search location, the search location operable to limit the search to a portion of the network;

59. The system of claim 56, wherein an available client comprises an idle terminal within the network.

60. The system of claim 56, wherein an available client comprises an idle server within the network.

61. The system of claim 56, wherein the client communication module is further operable to direct the data management to store a search status.

62. The system of claim 61, wherein the search status comprises a search that is waiting to be assigned to an available client.

63. The system of claim 61, wherein the search status comprises a search that has been assigned to an available client.

64. The system of claim 61, wherein the search status comprises a search that has been completed.

65. The system of claim 56, wherein the search data comprises a search result corresponding to a completed search.

66. The system of claim 65, wherein the search result comprises a file location, the file location corresponding to a location within the network.

67. The system of claim 66, wherein the location comprises a general location identifier, the general location identifier corresponding to a server group within the network.

68. The system of claim 67, wherein the location further comprises a folder within the server group.

69. The system of claim 56, wherein the search data comprises a search status and a search result, the database comprising a first storage area operable to store the search status, and a second storage area operable to store the search result.
